(19) United States
(12) Patent Application Publication
(10) Pub. No.: US 2007/0133427 A1
(43) Pub. Date: Jun. 14, 2007

(54) System and method for providing high speed content and services

(76) Inventors: Carolyn Taylor, Chicago Heights, IL (US); Thomas C. Hill, Crystal Lake, IL (US)

Correspondence Address: MOTOROLA, INC., 1303 EAST ALGONQUIN ROAD, IL01/3RD, SCHAUMBURG, IL, 60196, US

(21) Appl. No.: 11/301,485

(22) Filed: Dec. 13, 2005

(51) Int. Cl. H04J 1/16

(52) U.S. Cl. 370/252; 370/401

(57) ABSTRACT

A first communication is associated with a group. A backhaul path to a network (108) is determined for the first communication based upon a Quality-of-Service (QoS) level associated with the group. The first communication is backhauled to the network (108) via the backhaul path.

### FIELD OF THE INVENTION

The field of the invention relates to routing communications through networks and more specifically to providing various services to users of these networks.

### BACKGROUND OF THE INVENTION

Modern communication networks provide a large variety of services for users of these systems. For example, many of these systems provide video services, others provide voice communication services, and still others provide text messaging services. Typically, Quality-of-Service (QoS) levels are assigned to different services or associated with different users so that communications can be prioritized and processed in an orderly and predictable way.

Various network elements and topologies are used to allow communications to be exchanged between users. For instance, many low elevation communication sites may be needed (due to Shannon's limit) in order to effectively allow communications to be exchanged. Each of the communication sites may also require the ability to exchange information with other communications sites or with different networks or systems. A backhaul communication path is often selected to allow for communications to be made to the other sites and/or networks.

In previous systems, the selection of the backhaul communication path was made and based solely upon fixed considerations. For instance, in some previous approaches, backhaul communications were automatically transmitted to an outside network using the nearest communication site relative to the user. Unfortunately, in these previous systems, if the nearest communication site was overloaded or had other operational problems, this might not be the most efficient or effective approach. In another previous approach, a wireless channel was always used to relay the backhaul communications to a network. However, some types of communications were typically better made using wired sites. Because of the problems associated with using these fixed approaches, inefficiencies developed as communications better suited for being backhauled at one communication site or using particular types of transmission technology were backhauled at other communication sites or using inappropriate technologies. Consequently, the transmission speed of communications was significantly reduced, network efficiency often decreased, and frustration of users with the system increased.

### BRIEF DESCRIPTION OF THE DRAWINGS

FIG. 1 is a block diagram of a system for making backhaul communications to a network according to various embodiments of the present invention;

FIG. 2 is a flowchart of an approach for making backhaul communications to a network according to various embodiments of the present invention; and

FIG. 3 is a block diagram of a device for making backhaul communications to a network according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF EMBODIMENTS

A system and method exchanges communications with a network via a backhaul communication path. The particular path chosen is based upon a Quality-of-Service (QoS) level associated with the communication. By selecting the backhaul path based upon the QoS level, communications are exchanged quickly and efficiently.

In many of these embodiments, a communication is associated with a particular group. A backhaul path to a network is determined for the communication based upon a Quality-of-Service (QoS) level associated with the group and the communication is subsequently backhauled to the network via the backhaul path. In one example, the backhauling comprises selecting a communication site to transmit the communication to the network. In another example, the type of transmission technology (e.g., wired, wireless, or fiber) is chosen. The backhauling may also include transmitting another communication originating at the communication site to the network together with the original communication.

The communication may be separated into individual packets for ease of transmission. In one approach, at least some of these individual packets may be transmitted to a wired site for backhauling to the network and others of the individual packets to an unwired site for backhauling to the network. In another example, the communication may be transmitted to a mobile station, and then the mobile station may act as a repeater to transmit the communication to a network or to another communication site.

In others of these embodiments, the QoS level associated with a group may not be fixed and can be adjusted over time. In addition, different QoS levels may be assigned to different communications (or users) assigned to the group.

In still others of these embodiments, the QoS level (and hence the backhaul path) may be based upon a variety of factors. For example, the QoS level may be based upon temporal criteria and/or geographic criteria. In other examples, the identity of the customer and the level of service paid for by the customer may determine the QoS level and, therefore, the backhaul path.

Thus, approaches are described that dynamically determine an optimum backhaul communication path from a user to a network. Since these approaches for choosing the backhaul path are flexible and dynamic, the path determination considers a variety of factors, thereby improving network efficiency and the experience of users with the system.

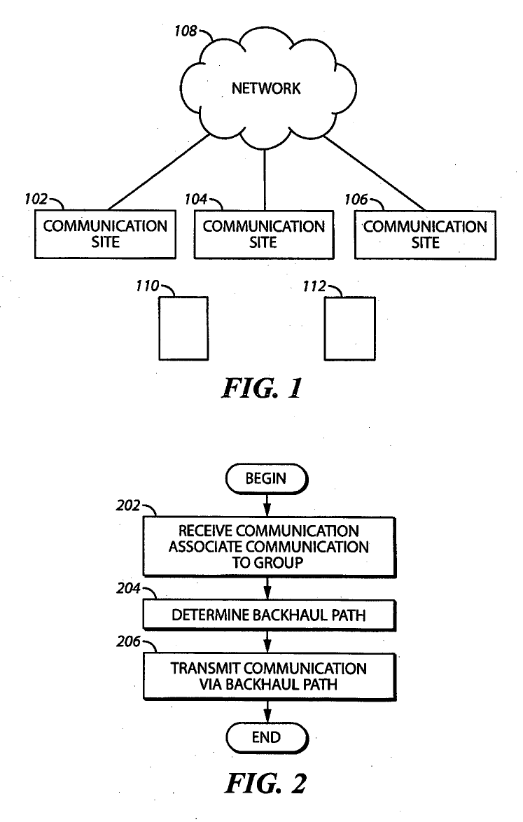

Referring now to FIG. 1, one example of a system for backhauling communications to a network is described. In this system, communication sites 102, 104, and 106 allow communications to be made between mobile stations 110 and 112, and a network 108. In addition, the sites 102, 104, and 106 may include elements or functionality that allow the sites to exchange communications with each other.

The communications sites 102, 104, and 106 may include a number of different elements that are used to perform various control, transmission, and reception functions. For example, the sites 102, 104, and 106 may include base stations or other Radio Access Network (RAN) elements that allow communications to be exchanged between the network 108 and mobile stations 110 and 112. The sites 102, 104, and 106 may also include a controller that determines the backhaul path for messages and communications to be sent to the network 108. The backhaul path may include the identity of a particular communication site to transmit the message as well as the communication technology to be used.

The network 108 may be any network or combination of networks. For example, the network 108 may be the Internet, a telephone network, a wireless network, a local area network, a wireless local area network, or some combination of these or other networks. The mobile stations 110 and 112 may be a cellular telephones, personal digital assistants (PDAs), pagers, or personal computers. Other examples of mobile stations are possible.

In one example of the operation of the system of FIG. 1, a communication transmitted by the mobile station 110 is associated with a group. The group has an associated Quality-of-Service (QoS) level. A backhaul path to the network 108 is determined for the communication based upon a QoS level associated with the group.

Information concerning the group may be stored at any element or any combination of elements within the system. In one preferred approach, the group information is shared between the sites 102, 104, and 106.

The QoS level (and hence the backhaul path) associated with a particular group may be based upon a number of factors. For example, the QoS level may be based upon the identity of the user that initiated the communication, the level of service paid for by the user that initiated the communication, the amount of usage by the user that originated the communication, the geographic location or usage patterns of the user that originated the communication, or the times of use or other temporal usage patterns by the user that originated the communication. Other factors may be used to choose the QoS level.

The QoS level associated with a group may cause certain sites to be selected. In one example, a high QoS level may dictate that a particular site be selected, while a lower QoS level may dictate that another site be selected.

In addition to a site identity, a transmission technology for sending of the backhaul information at the particular site to the network may also be selected. For instance, it may be determined whether to use wired, wireless, or fiber optic communication technology.

Other communications can be added to the communication once the site 102, 104, or 106 is selected. For example, the backhauling may also include transmitting another communication (or communications) originating at the selected communication site to the network 108 together with the original communication.

Furthermore, a number of different approaches can be used to transmit the information from the mobile station 110 to the network 108. For example, the communication may be separated into individual packets or other units of data. At least some of these individual packets may be transmitted to a wired site for backhauling and others of the individual packets to an unwired site for backhauling. The packets can be recombined at a central switch of the network 108 before forwarding to a central network location. In another example, the communications may be transmitted to another mobile station 112, and the mobile station 112 may act as a repeater to transmit the communications to the network 108 or to another communication site.

In addition, multiple QoS levels may be used for groups. For example, different QoS levels may be assigned to different communications (or different users) associated with the group. This approach may be used when certain users are paying more for a certain QoS as compared to other users.

The QoS may also be varied between different parts of the same message. For instance, the QoS may be varied by alternating between low bandwidth and high bandwidth sites in order to optimize traffic and provide the most cost effective approach for delivering the information.

Furthermore, the network sites 102, 104, or 106 may adjust the QoS levels. For example, the sites 102, 104, or 106 may reduce the QoS in order to use lower cost backhaul (e.g., a nearby site wired with copper wires). Alternatively, the site 102, 104, or 106 may increase the QoS in order to use higher cost backhaul, or for more convenient backhaul (e.g., a nearby site using fiber optic cable connections).

Backhauling may be provided by using multiple ones of the sites 102, 104, or 106. For instance, one communication site with fiber technology may be used for downloading information from the network 108 and another site with wireless technology may be used to upload information from the network 108. In this case, using fiber optic transmission technology to receive information from the network 108 may be more efficient and cost effective than a copper transfer technology or wireless transfer technology.

Site configuration can dynamically change to meet the needs of the network and the users. For example, traffic patterns may change the cost structures related to the network 108, thereby necessitating changes in QoS levels. Inexpensive sites that are less reliable may be added to the network to allow lower QoS-level hopping to be performed. In another example, sites that are densely concentrated may require the use of backhaul that is different than those at the edge of the network. This may be accomplished with an overlay of backhaul patterns (e.g., backhaul pattern X on top of backhaul pattern Y) or splitting backhaul patterns based on QoS and service requirements (e.g., fixed or temporal requirements).

The sites 102, 104, or 106 may also choose to perform broadband backhaul. In still another example, a master backhaul site (e.g., a wired site) may be selected from the sites 102, 104, and 106, and the other backhaul sites (e.g., wireless sites) may be temporal and defined based upon QoS patterns that can be dynamically redefined.

Referring now to FIG. 2, one example of an approach for backhauling communications from a user to a network is described. At step 202, a communication is received at a communication site and is associated with a group. The site is connected to a network (or networks) and communications are exchanged with the network via a backhaul path.

The group has an associated Quality-of-Service (QoS) level. Alternatively, multiple QoS levels may be associated with the group and these distinct QoS levels may relate to different users or communications associated with the group.

At step 204, a backhaul path to a network is determined for the communication based upon the QoS level associated with the group. The selection of a backhaul path includes a selection of a communication site and/or transmission technology.

Various factors can be used to choose a particular QoS level and, therefore, the communication site and/or particular transmission technology that is used. For instance, temporal considerations (e.g., the times during the day when a user is active), the geographic patterns of use by the user, and the level of service paid for by the user, may be used individually or in combination to determine the QoS level and, consequently, the backhaul path.

In one example, if a user is paying for a certain service level and is calling during a certain time of day, a certain QoS level may be chosen. In another example, if the user is paying for a different service level and is calling at a non-busy time of day, another QoS level may be chosen.

In addition, and as mentioned, the selection of the backhaul path may include determining a technology for exchanging the backhaul information. For instance, a particular QoS level may necessitate the use of certain technologies. Moreover, communication sites may offer one or more of these technologies. For instance, certain sites may offer wired, wireless, or fiber optic transmission technologies, while other sites may offer all of these technology types.

Different weighting factors may also be applied to the QoS determination. In one example, the paid-for service level of a user may have a heavy weighting, while temporal and geographic usage patterns may have less weighting. In still another example, the relative weighting factors can be reversed and the temporal and geographic patterns may receive a greater weighting.

At step 206, the communication is transmitted to the network via the backhaul path. As mentioned above, the backhaul path may comprise the technology used and the communication site used to make the transmission. In addition, other factors can also be used.

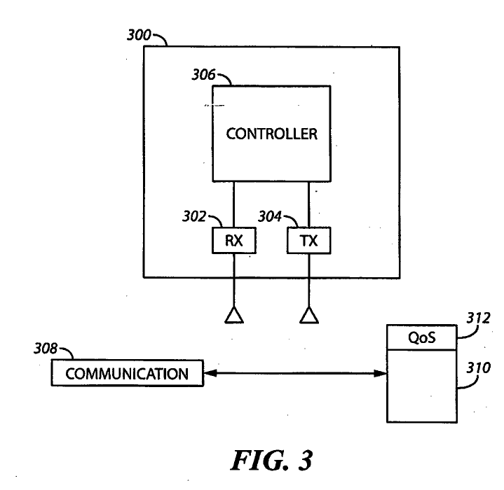

Referring now to FIG. 3, one example of a device for making backhaul communications to a network is described. The device 300 includes a receiver 302, a transmitter 304, and a controller 306.

The controller 306 is programmed to associate a communication 308 received at the input of the receiver with a group 310. For example, various user groups may exist and the communication may be assigned to the group 310 based upon the source of the communication or other factors associated with the source. The group has an associated Quality-of-Service (QoS) level 312. Based upon the QoS level 312, the controller 306 is programmed to determine a backhaul path to a network for the communication based upon the QoS level.

For example, the controller 306 may associate communications with a high QoS level 312 with certain communication sites and certain technologies. In another example, communications with a low QoS level 312 may be assigned to a communication site with other types of communication technologies.

Thus, approaches are described that allow an optimum backhaul communication path to be determined in a flexible manner. Since the approaches to choosing the path are flexible, the path determination can take into account a variety of considerations thereby improving network efficiency and the experience of users with the network.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of sending and receiving high speed and high bandwidth content communications and services comprising:
associating a first communication with a group;
determining a backhaul path to a network for the first communication based upon a Quality-of-Service (QoS) level associated with the group; and
backhauling the first communication to the network via the backhaul path.

2. The method of claim 1 wherein the backhauling comprises selecting a communication site to transmit the first communication to the network.

3. The method of claim 2 further comprising backhauling a second communication originating at the communication site to the network together with the first communication.

4. The method of claim 1 further comprising separating the first communication into individual packets.

5. The method of claim 4 further comprising transmitting at least some of the individual packets to a wired site and others of the individual packets to an unwired site.

6. The method of claim 1 wherein the backhauling comprises transmitting the first communication to a mobile station, the mobile station acting as a repeater.

7. The method of claim 1 further comprising assigning a different QoS level for a second communication associated with the group.

8. The method of claim 1 wherein determining the backhaul path comprises dynamically determining the backhaul path based upon predetermined criteria, the predetermined criteria selected from a group comprising: a temporal criteria and geographic criteria.

9. A method of transmitting and receiving high speed and high bandwidth content communications and services comprising:
receiving a first communication having a Quality-of-Service level related to a group to which the communication is associated; and
backhauling the first communication to a network via a backhaul path associated with the QoS level.

10. The method of claim 9 wherein the backhauling comprises operating a mobile station as a repeater to transmit the first communication to the network.

11. The method of claim 9 further comprising backhauling a second communication to the network along with the first communication.

12. A network element comprising:
a receiver having an input;
a transmitter having an output;
a controller coupled to the receiver and the transmitter, the controller being programmed to associate a communication received at the input of the receiver with a group, the group having an associated Quality-of-Service (QoS) level, the controller being further programmed to determine a backhaul path to a network for the communication based upon the QoS level.

13. The network element of claim 12 wherein the controller is further programmed to transmit the communication to a network node at the output of the transmitter, the network node being associated with the backhaul path.

14. The network element of claim 12 wherein the controller is further programmed to separate the communication into individual packets.

15. The network element of claim 14 wherein the controller is further programmed to transmit at least some of the individual packets to a wired site at the output of the transmitter and others of the individual packets to an unwired site at the output of the transmitter.
